(19) United States
(12) Patent Application Publication
(10) Pub. No.: US 2023/0356729 A1
(43) Pub. Date: Nov. 9, 2023

(54) Customizable Systems

(71) Applicant: Apple Inc., Cupertino, CA (US)

(72) Inventors: Jie Gu, Palo Alto, CA (US); Zhuo Gao, Palo Alto, CA (US)

(21) Appl. No.: 18/172,175

(22) Filed: Feb. 21, 2023

Related U.S. Application Data
(60) Provisional application No. 63/337,728, filed on May 3, 2022.

(51) Int. Cl. B60W 50/00; B60W 40/08; G06V 20/59; G06V 40/16; H04W 4/48; H04W 4/80

(52) U.S. Cl. CPC B60W 50/0098; B60W 40/08; G06V 20/59; G06V 40/172; H04W 4/48; H04W 4/80; B60W 2420/22; B60W 2420/42; B60W 2420/54; B60W 2540/043; B60W 2540/221; B60W 2540/223

(57) ABSTRACT

A system may have sensors that gather information on users. The users may have portable electronic devices such as wristwatches, cellular telephones, and computers. The sensors may include facial recognition image sensors, fingerprint sensors, voice sensors configured to identify users by voice, and other biometric sensors. Pressure sensors may be used to measure the weight of users to help identify the users and/or to determine their age. Using the sensors, user identities and user positions may be ascertained. The system may have equipment such as adjustable seats, climate control systems, media systems, and other components that can be customized based on the identities and user positions.

This application claims the benefit of provisional patent application No. 63/337,728, filed May 3, 2022, which is hereby incorporated by reference herein in its entirety.

### FIELD

This relates generally to systems with sensors, and, more particularly, to using sensors to customize systems.

### BACKGROUND

Systems may have adjustable components. These adjustable components may include, for example, adjustable media systems and adjustable seats. It may be desirable to facilitate adjustment of such components.

### SUMMARY

A vehicle may have sensors that gather information on vehicle occupants and/or electronic devices being used by the vehicle occupants. Using the sensors, vehicle occupant identities and vehicle occupant locations may be ascertained. The electronic devices of the vehicle occupants may include portable electronic devices such as wristwatches worn by the vehicle occupants and cellular telephones and computer used by the vehicle occupants. The sensors may include facial recognition image sensors, fingerprint sensors, microphones used to identify users by voice, and other biometric sensors. Seat pressure sensors may be used to measure the weight of vehicle occupants to help identify the occupants and/or to determine their age. Wireless sensors such as wireless transceivers that use time-of-flight measurements, signal strength measurements, and/or other measurements and bidirectional wireless communications between the sensors and the portable electronic devices (e.g., communications to ascertain device identifiers, usernames, and other information identifying a user of a device) may be used to interact with the portable electronic devices to determine the identities of the users of these devices and their locations.

The vehicle may have equipment such as adjustable seats, climate control systems, media systems, and other components that can be customized based on the identities and locations of vehicle occupants. For example, the position of an adjustable seat in the right rear portion of the vehicle may be customized to accommodate an occupant located in the right rear portion of the vehicle, media playback preferences (favorites, history items such as last-viewed episodes, age-based restrictions, favorite genres, watchlist items, and/or other media system settings), climate control settings, volume settings and other audio system settings, and other adjustable components settings may also be customized based on the identities and locations of occupants. If desired, messages may be transmitted wirelessly from the vehicle to the portable electronic devices of vehicle occupants. As an example, a warning message may be transmitted to an occupant upon exiting a vehicle to remind the occupant that a pet, device, or other item has been left behind.

### BRIEF DESCRIPTION OF THE DRAWINGS

FIG. 1 is a schematic view of an illustrative system of the type that may include a vehicle in accordance with an embodiment.

FIG. 2 is a top view of an illustrative vehicle in accordance with an embodiment.

FIG. 3 is a flow chart of illustrative operations involved in customizing a vehicle such as the vehicle of FIG. 2 in accordance with an embodiment.

### DETAILED DESCRIPTION

A system such as a vehicle may have adjustable components. These components may include speakers, displays, and other components that form an adjustable media system, seats, mirrors, lights, air-conditioning units, and/or other components that form adjustable vehicle systems (e.g., climate control systems, seating systems, driving systems, etc.), and/or may form other vehicle subsystems. During vehicle operation, a vehicle may gather information on vehicle users and may use this information in customizing the operation of vehicle components and/or taking other suitable action (e.g., providing users with notifications, etc.). As an example, upon identifying that person X is located in seat Y of a vehicle, a media playback system for seat Y may be customized to present media that is customized for person X. As another example, climate control functions associated with seat Y may be adjusted in accordance with the preferences of person X.

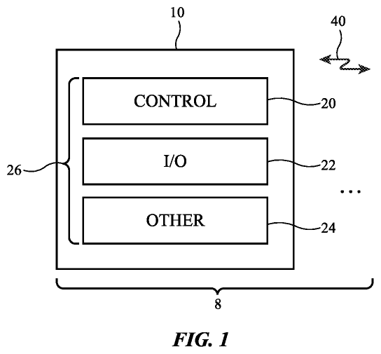

FIG. 1 is a diagram of an illustrative system of the type that may gather information on vehicle users and that may use this information in customizing vehicle operation or taking other suitable action. As shown in FIG. 1, system 8 may include one or more systems (subsystems) 10. Systems 10 may communicate over wired and/or wireless communications links (see, e.g., wireless communications paths 40). Systems 10 may include vehicles, electronic devices such as cellular telephones, wristwatch devices, laptop computers, tablet computers, and other portable electronic equipment, remote databases and other systems implemented on servers or other computer equipment, and/or other systems. As an illustrative example, system 8 may include a vehicle such as an automobile that is occupied by one or more vehicle occupants (sometimes referred to as users), may include personal electronic devices associated with each such occupant (e.g., a cellular telephone used by each vehicle occupant, a wristwatch used by each occupant, and/or other electronic device(s) used by each occupant), and may include remote electronic equipment (e.g., media servers and/or other servers accessed through the internet and/or other networks). An online service provider may be associated with the media servers or other cloud computing equipment that is accessed through the internet. Vehicle occupants may have accounts with the online service provider that allow the vehicle occupants to obtain photos, email and other messages, video and audio, and other media (e.g., these items may be obtained wirelessly by equipment in a vehicle over the internet).

Each system 10 may include one or more components 26. Components 26 may include control circuitry 20, input-output devices (input-output circuitry) 22, and/or other components 24.

Control circuitry 20 may include be used in adjusting the operation of components such as media system components and other components. As an example, in a vehicle, control circuitry 20 may be used in adjusting components in the vehicle such as seats (e.g., adjustable seat positioners), mirrors, interior and/or exterior vehicle lighting, windows, climate control systems, etc. Control circuitry 20 may run software for controlling components 26. For example, in a vehicle, control circuitry 20 may run software for controlling vehicle systems such as fans, air heaters, and/or air-conditioners that cool air and vehicle systems that handle lighting, media playback, window movement, window transparency, door operations, seating settings, sensor operations, transmission settings, and/or other vehicle operations.

Control circuitry 20 may include processing circuitry and storage and may be configured to perform operations in system 8 using hardware (e.g., dedicated hardware or circuitry), firmware and/or software. Software code for performing operations in system 8 and other data is stored on non-transitory computer readable storage media (e.g., tangible computer readable storage media) in the control circuitry. The software code may sometimes be referred to as software, data, program instructions, computer instructions, instructions, or code. The non-transitory computer readable storage media may include non-volatile memory such as non-volatile random-access memory, one or more hard drives (e.g., magnetic drives or solid-state drives), one or more removable flash drives or other removable media, or other storage. Software stored on the non-transitory computer readable storage media may be executed on the processing circuitry of control circuitry 20. The processing circuitry may include application-specific integrated circuits with processing circuitry, one or more microprocessors, a central processing unit (CPU) or other processing circuitry. Control circuitry 20 may include wireless communications circuitry (transceivers, antennas, etc.) that supports wireless communications over any suitable wireless links 40 in system 8 such as cellular telephone links, wireless local area network links (e.g., WiFi® links, Bluetooth® links, near-field communications (NFC) links, millimeter wave links, ultra-wideband (UWB) communications links, satellite communications links, and/or other wireless communications paths. Wireless communications circuitry (e.g., transceivers, antennas, etc.) that supports communications over short range wireless links such as links characterized by distances of centimeters or meters (e.g., Bluetooth, UWB, NFC, and/or WiFi) may sometimes be referred to as short-range wireless communications circuitry. Short range communications circuitry may be used in determining the location of systems 10 relative to each other in system 8, so short-range communications circuitry in systems 10 may sometimes be referred to as wireless sensor circuitry, sensor circuitry, or sensors. For example, in a vehicle, short-range communications may be used in determining which seat of the vehicle is occupied by a user wearing a wireless wristwatch device that is communicating with equipment in the vehicle using short-range communications.

The input-output devices 22 may include displays, sensors, buttons, light-emitting diodes and other light-emitting devices, haptic devices, speakers, and/or other devices for gathering environmental measurements, information on system operations (e.g., vehicle operations in a system such as a vehicle), and/or user input. User input may also be received wirelessly from an external system using the communications circuitry of circuitry 20. The sensors in devices 22 may include ambient light sensors, touch sensors, force sensors, proximity sensors, temperature sensors, optical sensors such as cameras operating at visible, infrared, and/or ultraviolet wavelengths (e.g., fisheye cameras, two-dimensional sensors such as two-dimensional visible and/or infrared cameras, three-dimensional sensors such as visible and/or infrared structured light cameras, time-of-flight cameras, stereoscopic cameras, and/or other three-dimensional cameras), capacitive sensors, resistive sensors, ultrasonic sensors (e.g., ultrasonic distance sensors), microphones, radio-frequency sensors such as radar sensors, lidar (light detection and ranging) sensors, door open/close sensors, seat pressure sensors (e.g., sensors for measuring vehicle occupant weight) and other vehicle occupancy sensors such as camera-based sensors that can detect whether a vehicle is occupied, window sensors, position sensors for monitoring location, orientation, and movement, speedometers, satellite positioning system sensors, and/or other sensors. Output devices in devices 22 may be used to provide users (e.g., vehicle occupants in a vehicle system) and others with output. For example, a haptic output device may provide a user with haptic output (e.g., force feedback, vibrations, etc.), a speaker may be used to provide a user with sound (audio output), and a touch screen display, touch insensitive display, and/or other light-emitting device (e.g., one or more light-emitting diodes) may be used to provide visual output (e.g., displayed content, light, status indicator lamp output, etc.).

Each system 10 may also include other components 24. For example, a vehicle may contain a steering and propulsion system (e.g., a computer-controlled driving system implemented on control circuitry in the vehicle that operates under manual control from a user and/or that operates autonomously). The steering and propulsion system (sometimes referred to as the driving system or vehicle system) may use actuators to steer wheels that are coupled to the vehicle and may use propulsion-controlling components such as brakes, motors, and transmission components, to adjust vehicle speed.

During operation, control circuitry 20 may use sensors in devices 22 to make environmental measurements (e.g., measurements on temperature, ambient light levels, etc.) and biometric measurements (e.g., measurements of user facial features, fingerprints, voice signatures, etc.). Sensors (e.g., capacitive touch sensors, microphones, button switches, etc.) may also be used to gather user touch input, user force input, user voice commands, user button presses, and/or other user input. Wireless sensors may gather information on the portable devices of users. Based on this information, a vehicle and/or other systems in system 8 may be customized. As an example, a face scan may be used to identify a vehicle occupant and to identify which seat within a vehicle is being occupied by that occupant. In response, the control circuitry of the vehicle may customize the position of the seat (e.g., seat positioners may be used to recline and/or otherwise adjust the seat position), may customize media playback options (e.g., an online service provider account of a vehicle occupant may be accessed and/or other occupant media information may be retrieved from local storage information so that a display may display radio stations, audio tracks, videos, genres, and/or other items that are favorites or recently used items for that vehicle occupant), and/or may customize other vehicle settings (lighting, mirror positions, window attributes, vehicle transmission sport/comfort settings, navigation system settings, audio volume, bass/treble settings, settings indicating which particular speaker or set of speakers in a vehicle are used in presenting the vehicle occupant with audio, which display is active, and/or any other adjustable vehicle component settings). If desired, the information gathered with sensors may be used to send wireless reminders and other wireless messages to the portable devices of vehicle users. For example, a camera and/or a seat pressure sensor may detect when a vehicle user has left a pet behind in a vehicle and, in response, a notification may be wirelessly transmitted to the devices of the user informing the user of this fact.

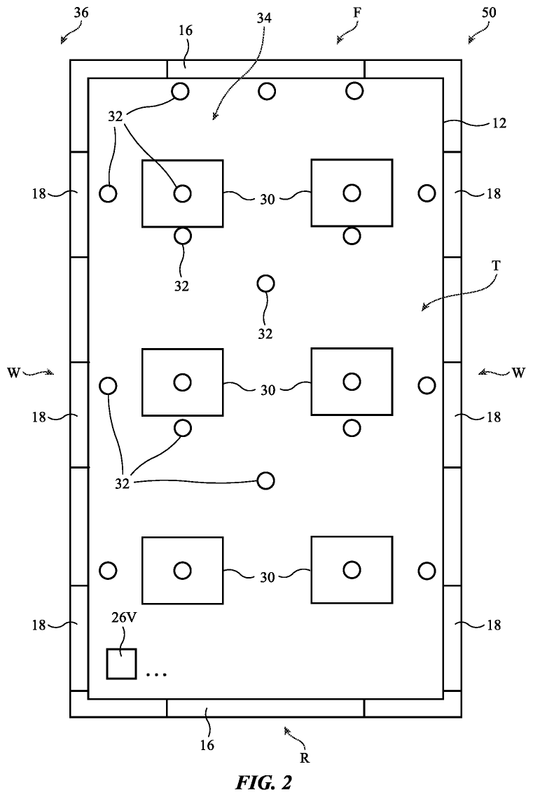

FIG. 2 is a top view of an illustrative vehicle (one of systems 10 in FIG. 1). Vehicle 50 of FIG. 2 may be manually driven (e.g., by a human driver), may be operated via remote control, and/or may be autonomously operated (e.g., by an autonomous vehicle driving system implemented using the control circuitry, sensors, and other components of vehicle 50).

Vehicle 50 may include a body such as body 12. Body 12 may include vehicle structures such as body panels formed from metal and/or other materials, may include doors, a hood, a trunk, fenders, a chassis to which wheels are mounted, a roof, etc. Windows 16 may be formed in doors 18 (e.g., on sides W of vehicle body 12), may be formed in roof T of vehicle 50, may be formed at front F and/or rear R of vehicle 50, and/or in other portions of vehicle 50. Windows 16, doors 18, and other portions of body 12 may separate the interior of vehicle 50 (interior region 34) from the exterior environment that is surrounding vehicle 50 (exterior region 36). Windows 16 may include a front window (sometimes referred to as a front windshield), a rear window, and/or other windows.

Vehicle 50 may include components 26V. Components 26V may include a steering and propulsion system (e.g., a computer-controlled driving system implemented on control circuitry 20 in vehicle 50 that operates under manual control from a user and/or that operates autonomously). The steering and propulsion system (sometimes referred to as the driving system or vehicle system) may have wheels coupled to body 12, steering actuators coupled to the wheels to turn the wheels, one or more motors for driving the wheels, brakes, transmission components, etc., and other vehicle systems. Components 26V may include output components such as displays, speakers, haptic output devices, devices for providing interior illumination (lighting) for interior region 34, a climate control system such as a heating ventilation and air-conditioning (HVAC) system, and other components (see, e.g., components 26 of FIG. 1).

Seating 30 may include one or more forward facing seats, one or more rear-facing seats, and/or seats that face towards each other (e.g., rear-facing seating and opposing forward-facing seating). Motors and other devices may be used to make seat adjustments to seating 30 (e.g., tilt adjustments, forward-rearward sliding adjustments, lumbar support adjustments, seat heater adjustments, seat massager adjustments, etc.). Vehicle 50 may be occupied by one or more users (e.g., one or more vehicle occupants may sit on each of the seats in seating 30). Sensors 32 (sometime referred to as sensor circuitry) may be located within seat cushions in seats in seating 30, on the backs of seats in seating 30 (e.g., so that a camera or other sensor on a given seatback faces the front of a vehicle occupant sitting in a seat directly behind that seatback), on roof T of vehicle body 12 (e.g., facing forwards and/or rearwards towards vehicle occupants), on a dashboard or other support structure at front F of vehicle body 12, on the interior panels of body 12 at sides W or on rear R, and/or elsewhere in vehicle body 12. If desired, other input-output devices such as touch screen displays, microphones, speakers, keyboards, buttons, knobs, light sources, and/or other devices for providing input and output may be co-located with sensors 32, may be located adjacent to sensors 32, and/or may be placed at any other suitable locations within vehicle 50 (e.g., in interior region 34).

Sensors 32 (sensor circuitry 32) may include wireless communications circuitry (e.g., short-range wireless communications circuitry and/or sensor circuitry such as receivers and/or transmitters having Bluetooth circuitry, WiFi circuitry, NFC circuitry, and/or UWB circuitry). Triangulation, time-of-flight measurements using beacons and/or other wireless signals, signal strength measurements, and/or other wireless measurements may be made by this short-range wireless communications circuitry (sensor circuitry) to determine where vehicle occupants are located. As an example, a user may be wearing a wireless wristwatch, a pair of augmented reality glasses, a pair of earbuds, or other wearable electronic device and/or may be carrying a portable electronic device such as a cellular telephone or other electronic device in a pocket or may otherwise be holding or supporting such a portable electronic device. The user may also be carrying a wireless smart card or wireless vehicle key fob. In these situations, wireless measurements from multiple different short-range wireless communications sensors, may be used to ascertain where an electronic device of a user (and therefore the user) are located within interior region 34 (e.g., which seat is occupied by the user). Wireless sensor measurements may therefore be used both to identify users (vehicle occupant identities) and to ascertain user locations (vehicle occupant locations).

Another way in which to identify users and determine user locations involves gathering biometric measurements. Image sensors (cameras in sensors 32 that are configured to serve as facial recognition sensors) may be used to capture images of users. Facial recognition operations and/or other pattern recognition operations may then be used to identify users. Known image capture locations and/or image capture directions (fields of view) may be used in identifying the locations of each user within interior region 34. If desired, audio sensors (microphones in sensors 32) may be used to detect user voices. Voice localization operations (e.g., time-of-flight and/or triangulation analysis) may be used to determine the locations of speakers. Voice pattern recognition operations may be used to determine the identity of each user (e.g., microphones may gather voice prints). Fingerprint sensors in sensors 32 (e.g., a fingerprint sensor adjacent to each seat in vehicle 50) may be used to determine user identify and user location, seat pressure sensors in sensors 32 (e.g., a pressure sensor in each seat that measures the weight of the occupant of that seat) may also be used in identifying and locating users, as may any other type of biometric sensor (e.g., iris scanning cameras, palm print sensors, body outline sensors, height sensors, handwriting recognition sensors, etc.). Users may also be provided with opportunities to enter a user identifier and password or other user credentials (e.g., online service provider credentials) by typing, voice input, etc. For example, each seat in vehicle 50 may have an associated touch screen display, touch pad, keyboard and/or keypad, microphone, mouse, and/or other user input device(s). This allows each user to provide a username and password, personal identification number (PIN), and/or other login credentials. From this user input, user location and identity may be ascertained.

Upon determining the location and identity of each user, vehicle operations may be customized for each user and/or other suitable action may be taken. Consider, as an example, media functions. Media may be provided to uses from local storage and/or from remote media servers or other remote equipment associated with an online service provider that is in wireless communication with vehicle 50. Each user may have different favorite settings (favorite channels, volume levels, bass and treble settings, favorite genres) and may have a different media viewing history (e.g., a different history of recently played audio and/or video media tracks). Upon identifying that a given user is present, that user may be automatically presented with their recent viewing history (including partially played media which can be resumed from the user's most recent pause point), may be presented with options to select favorite channels, programs, genres, etc., may be presented with media using default speaker configurations, volume levels, brightness levels, and/or may otherwise be provided with a media selection and consumption environment that is tailored to that user. Customized media selection functions (e.g., operations related to presenting favorites, history information, etc.) may be provided using custom menu options on touch screen displays (as an example). Custom playback functions (e.g., custom display settings, custom audio system settings) may be provided by automatically adjusting display attributes (brightness, color cast, contrast, etc.) and/or may be provided by automatically adjusting audio system attributes (active speakers, volume levels, bass and treble settings, etc.). Media access and playback functions can also be tailored in an age-appropriate fashion. For example, particular videos or games may be accessed only when a user is identified as an adult. This media content may not be made available to children. Restrictions may also be imposed on children such as screen-time restrictions, audio volume restrictions, genre restrictions, etc. User age may be assessed using previously supplied registration information (e.g., user age information that is supplied to vehicle 50, an online service provider, and/or other equipment in system 8 when that user initially registers with that equipment and/or service provider) and/or sensor measurements (e.g., weight measurements indicating that a user has a child's weight).

Consider, as another example, the adjustment of vehicle hardware. Vehicle 50 may contain mirrors, seats, sunshades, windows, steering wheels, pedals, other steering and propulsion control devices, and/or other equipment that contains motors, linear electromagnetic actuators, and/or other positioning equipment. Using positioners, vehicle 50 can move seats forwards and backwards, can adjust seat tilt, can adjust lumbar support, can adjust thigh support, and/or can adjust other positions for the portions of a seat (seat cushion, rear cushion, headrest, arm rests, lumbar cushion, thigh support cushion, etc.). Positioners may also be used to advance, retract, and tilt steering wheels, adjust the angular orientation of side mirrors, and control the position and other physical attributes of movable vehicle components. When a driver or passenger of vehicle 50 makes manual adjustments to these components (e.g., by making seat position adjustments, steering wheel adjustments, mirror adjustments, etc.), these user preferences can be saved. Later, when a user is identified by vehicle 50, the saved hardware settings for that user can be retrieved and automatically used to adjust seating, mirrors, and/or other vehicle hardware (e.g., climate control components such as fans, heaters, and air-conditioning units). Airbag settings, door locking operations, and other vehicle settings may also be adjusted based on user identify. As an example, airbags may be deactivated when appropriate to enhance safety for small children.

In addition to adjusting media settings and hardware settings, vehicle 50 can use information on user identify and location to provide customized messages. As an example, incoming wireless communications for a given user may be routed to the input-output device(s) associated with the seat in which the given user is sitting. If a user exits vehicle 50, wireless messages may be sent to the user's electronic device from the vehicle. As an example, vehicle 50 may use a camera, seat pressure sensor, and/or other vehicle occupancy sensor(s) in sensors 32 to detect when a child or pet has been left behind in vehicle 50. To make sure that the user is alerted to this situation, vehicle 50 may send a wireless message to the portable electronic device(s) of the user or users who have exited vehicle 50. As just one example, if a camera captures an image of a pet after a user has exited vehicle 50 and locked the doors to vehicle 50, vehicle 50 may send a wireless notification to the cellular telephone or other electronic device of the user. The wireless notification may inform the user that the pet is still in the vehicle. If desired, the wireless notification may include an image of the pet as captured by the camera. Customized messages may also be sent in the event that a user leaves an electronic device within vehicle 50. As an example, if a user leaves a laptop computer or other electronic device on a seat of vehicle 50, vehicle 50 may send a reminder message to the cellular telephone or watch of the user to inform the user that the laptop computer is still in the vehicle. Reminders to users to take their devices with them as they exit the vehicle may also be provided using speakers (e.g., by issuing an audible alert as the user exits the vehicle in the event that a device is detected by sensor(s) 32.

Sometimes the users of vehicle 50 are previously known to vehicle 50 or an online service provider associated with vehicle 50. In this scenario, the users may have already registered with vehicle 50 and/or the associated service provider and may therefore have provided vehicle 50 and/or the associated service provider with user credentials (e.g., a username and password, fingerprint, facial scan, and/or other registration information and/or biometric details). During registration and/or later during use of one or more systems 10 (e.g., during use of a cellular telephone, during use of vehicle 50, etc.), the user may provide preferences (e.g., media preferences, vehicle hardware preferences, etc.). Whenever these users are detected in vehicle 50, vehicle 50 can automatically customize some or all of vehicle 50 for each detected user (e.g., the seat and associated portions of vehicle 50 being used by each detected user may be adjusted to the user's preferences).

Other users of vehicle 50 may be new users and may therefore never have interacted with vehicle 50 or the service provider associated with vehicle 50. In this scenario, vehicle 50 may, in response to determination that a user in vehicle 50 is an unknown user, offer that user an opportunity to register with vehicle 50 and/or an online service provider associated with vehicle 50. The online service provider may, as an example, have one or more servers for accepting registration information, saving user preferences, storing media for playback in accordance with user preferences and requests, etc. In the absence of user-provided preference information, vehicle 50 can set the seat of the user and other vehicle hardware to default configurations, can set media playback settings to defaults, and/or may otherwise adjust vehicle 50 (or at least the portion of vehicle 50 associated with the seat in which the user is sitting) to default configurations. The user may, if desired, be provided with an option to interact with vehicle 50 as a guest (e.g., to receive media as a guest without registering).

Users of vehicle 50 may be long-term users who return to vehicle 50 repeatedly (e.g., when vehicle 50 is privately owned by an individual or a family). Vehicle 50 may provide such users with an on-screen option to “trust this vehicle”. Selection of this option by a user allows vehicle 50 to retain user login information for that user and thereby facilitate subsequent interactions of the user with vehicle 50 (e.g., the user may resume use of their account without repeatedly authenticating to the vehicle). In other situations, users may be guests such as when vehicle 50 is owned by a ride sharing service or a friend. Such users would not select the “trust this vehicle option” or would select a “do not trust this vehicle option”. In response, vehicle 50 would not retain any personal information of the user when the user exits vehicle 50, thereby enhancing user privacy. If desired, a guest user may set a trust period. For example, a user may select a “trust this vehicle for 5 days” option. In response, vehicle 50 will retain the user's settings to facilitate user interactions with the vehicle for 5 days, after which vehicle 50 can delete all personal information on the user to enhance user privacy.

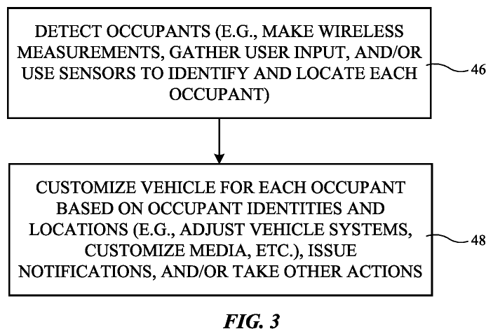

FIG. 3 is a flow chart of illustrative operations involved in using vehicle 50.

During the operations of block 46, vehicle 50 may use wireless circuitry, microphones, cameras, seat pressure sensors, and/or other sensors 32 to gather information on vehicle occupants. From this gathered information, control circuitry 20 may determine where each vehicle occupant is located within interior region 34 and may determine the identity of each vehicle occupant. Examples of techniques that may be used for monitoring users in vehicle 50 include: a) using one or more wireless transceivers to determine where the wristwatches, cellular telephones, computers, and/or other electronic devices of the users are located within interior region (and thereby determining in which seats the users of these devices are located), b) using image capture and image processing techniques such as facial recognition techniques to identify users and determine user locations (sometimes referred to as vehicle occupant seat positions); c) using microphones to determine the identities and locations (seat positions) of users, d) using seat pressure sensors to determine the locations (seat positions) of users, to determine the approximate ages of users (e.g., whether users are children or adults), and to help identify users; e) using fingerprint sensors to determine the identities and locations (seat positions) of users, f) using other sensors 32 to determine the identities and locations (seat positions) of users, g) using user input (e.g., user credentials such as a userID and password, PIN, etc.) to determine the identities and locations (seat positions) of users, and/or using other factors to determine the identities and/or locations (seat positions) of users. The operations of block 46 may involve detection of pets and inanimate objects (e.g., computers, etc.) in vehicle 50.

During the operations of block 48, vehicle 50 (e.g., control circuitry 20, input-output devices 22, and/or other components 24 and may process the user identity and user location information (seat position information) obtained during the operations of block 46 and use this information in customizing the components of vehicle 50, issuing notifications (e.g., audible, visual, and/or wireless alert messages, etc.) and/or taking other suitable actions. Customization operations may involve presenting each identified user with on-screen options pre-populated with favorites, history items, and/or other items associated with that user (e.g., lists of favorite media channels, favorite media tracks, favorite genres, recommendations based on user preferences and viewing history information, etc.), may involve audio system adjustments (e.g., volume setting adjustments, etc.), may involve adjustments to movable vehicle hardware (seats, mirrors, steering wheels and other steering and propulsion devices, etc.), adjustments to climate control systems and lighting, and adjustments to other vehicle systems based on the identity of each user. These customization operations may take into account the location (sometimes referred to as the vehicle occupant seat position) of each identified user. For example, if a user is determined to be sitting in the right rear of vehicle 50, the speakers adjacent to the right rear seat of vehicle 50 may be activated using the volume preference of the identified user in the right rear seat.

Notifications can be issued during the operations of block 48. Notifications can be issued using the audio and video components of vehicle 50. For example, a tone, a voice message, or other audible message may be played for users using the speakers and other audio system components of vehicle 50. Visual notifications can be presented using flashing light-emitting diodes, using displays that display text and/or graphics, and/or by otherwise supplying a user with visual output messages. In some situations, notifications can be sent wirelessly to equipment associated with one or more users. As an example, a notification message may be wirelessly transmitted to a user's cellular telephone or one or more other portable electronic devices. Wireless messages may be sent by vehicle 50 to identified user(s) in response to conditions detected by analyzing the information gathered during the operations of block 46. For example, if image processing operations and/or sensor output from one or more of sensors 32 detects that a pet is present in vehicle 50 after an identified user of vehicle 50 has exited vehicle 50 (and, if desired, after that user has locked vehicle 50 or performed other tasks and/or after other conditions such as hot exterior temperature conditions have been satisfied), vehicle 50 may use its wireless communications circuitry to send a wireless message (e.g., a text message, email, or other wireless message) that serves as an alert notifying the user of the presence of the detected pet. Wireless message such as these may also be sent whenever vehicle occupants and/or electronic device(s) are left behind by a user in vehicle 50. For example, if a vehicle is occupied by a front-seat user and a rear-seat user (e.g., a child), vehicle 50 may, upon detection that the front-seat user has exited vehicle 50, send a notification to the front-seat user that informs the front-seat user that the rear-seat user is still present in vehicle 50. The front-seat user may likewise be notified if the front-seat user leaves an electronic device behind in vehicle 50 when exiting vehicle 50. In general, wireless notifications, audible alerts (e.g., messages played externally using internal and/or external speaker(s) in vehicle 50), visible alerts (e.g., flashing lights, messages presented as text and/or graphics on an internally visible or externally visible display), and/or any other suitable messages (alerts, notifications, etc.) may be provided to one or more users. When users have been identified, messages may be wirelessly sent to the known device or devices of that user (e.g., devices identified as having previously been present in vehicle 50 or associated with users identified as being present in vehicle 50). When users have not been identified (e.g., because such users are guests who have not registered with vehicle 50 and/or an online service provider associated with vehicle 50), audible and/or visual alerts may be presented to these users and all others in the vicinity of vehicle 50.

The foregoing is merely illustrative and various modifications can be made to the described embodiments. The foregoing embodiments may be implemented individually or in any combination.

What is claimed is:

1. A vehicle, comprising:
a vehicle body separating an exterior region surrounding the vehicle body from an interior region within the vehicle body;
an image sensor coupled to the vehicle body that is configured to capture facial recognition information on a user in the interior region to determine an identity and a location of the user; and
equipment in the vehicle that is customized based on the identity and location of the user.

2. The vehicle defined in claim 1 wherein the location comprises a seat position of the user within the interior region and wherein the equipment comprises adjustable seating in the vehicle that is customized based on the identity of the user and the seat position of the user.

3. The vehicle defined in claim 1 wherein the equipment comprises a media system having a display and wherein the media system is configured to present user-specific items on the display based on the identity of the user.

4. The vehicle defined in claim 1 wherein the image sensor is configured to capture an image of the interior region and wherein the vehicle further comprises wireless communications circuitry configured to wirelessly transmit a message that includes the image of the interior region.

5. The vehicle defined in claim 4 wherein the vehicle includes wireless circuitry configured to detect a portable electronic device in the vehicle interior and wherein the wireless communications circuitry is configured to wirelessly transmit the message to the detected portable electronic device.

6. The vehicle defined in claim 5 wherein the wireless circuitry comprises at least one ultrawideband wireless transceiver.

7. The vehicle defined in claim 1 wherein the equipment comprises an adjustable mirror that is adjusted based on the identity and the location of the user.

8. The vehicle defined in claim 1 wherein the equipment comprises a climate control system that is adjusted based on the identity and the location of the user.

9. The vehicle defined in claim 1 further comprising seats, wherein the location of the user comprises a seat position of the user among the seats, wherein the image sensor is configured to use the facial recognition information to determine the seat position of the user, and wherein the equipment comprises adjustable vehicle hardware that is customized based on the identity of the user and the seat position of the user.

10. The vehicle defined in claim 1 further comprising seats, wherein the location of the user comprises a seat position of the user among the seats, wherein the image sensor is configured to use the facial recognition information to determine the seat position of the user, and wherein the equipment comprises a display configured to display media received wirelessly from an online service provider based on the seat position of the user and based on the identity of the user.

11. A vehicle, comprising:
a vehicle body separating an exterior region surrounding the vehicle body from an interior region within the vehicle body;
sensor circuitry in the vehicle body configured to determine vehicle occupant identities and vehicle occupant seat positions; and
a media system in the vehicle that includes a display, wherein the media system is configured to present customized media options on the display based on a vehicle occupant identity and vehicle occupant seat position determined by the sensor circuitry.

12. The vehicle defined in claim 11 wherein the sensor circuitry comprises at least one wireless transceiver selected from the group consisting of: a Bluetooth® transceiver, a near-field communications transceiver, and a WiFi® transceiver.

13. The vehicle defined in claim 12 wherein the sensor circuitry comprises at least one ultrawideband transceiver.

14. The vehicle defined in claim 11 wherein the sensor circuitry comprises a wireless transceiver configured to determine the vehicle occupant identities and vehicle occupant seat positions by communicating with vehicle occupant portable electronic devices selected from the group consisting of: vehicle occupant cellular telephones and vehicle occupant wristwatches.

15. The vehicle defined in claim 11 wherein the sensor circuitry comprises microphones and wherein the microphones are configured to determine the vehicle occupant identities.

16. The vehicle defined in claim 11 wherein the sensor circuitry comprises seat pressure sensors and wherein the seat pressure sensors are configured to determine the vehicle occupant seat positions.

17. The vehicle defined in claim 16 wherein the media system is configured to present customized media options on the display based at least partly on weight information from the seat pressure sensors.

18. The vehicle defined in claim 11 further comprising wireless communications circuitry configured to send a wireless message to a portable electronic device of a user based on information on the vehicle occupant identities.

19. A vehicle, comprising:
a vehicle body separating an exterior region surrounding the vehicle body from an interior region within the vehicle body;
sensor circuitry in the vehicle body that is configured to ascertain an identity of a user of the vehicle in the interior region, wherein the sensor circuitry comprises a selected one of: a) a facial recognition sensor, b) a microphone, and c) a wireless transceiver configured to detect a portable electronic device of the user that is selected from the group consisting of: a wristwatch device of the user and a cellular telephone of the user; and
adjustable equipment in the vehicle that is customized based on the identity.

20. The vehicle defined in claim 19 wherein the adjustable equipment in the vehicle comprises equipment selected from the group consisting of: adjustable seating, an adjustable climate control system, and an adjustable media system.

21. The vehicle defined in claim 20 wherein the sensor circuitry comprises an ultrawideband transceiver configured to determine a seat position associated with the portable electronic device of the user.
